(19) United States
(12) Patent Application Publication
(10) Pub. No.: US 2004/0014630 A1
(43) Pub. Date: Jan. 22, 2004

(54) Detergent tablet

(75) Inventor: Rafael Lopez, North Brunswick, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/198,681

(22) Filed: Jul. 17, 2002

(51) Int. Cl. C11D 17/00

(52) U.S. Cl. 510/445; 510/446; 510/447

(57) ABSTRACT

A detergent tablet comprising from about 80% to about 100%, by weight of the tablet, of detergent granules, the granules comprising (a) from about 5% to about 30%, by weight of the granules, of an anionic surfactant; (b) from about 2% to about 15%, by weight of the granules, of acetic acid salt; (c) from about 50% to about 80%, by weight of the granules, of a solid ingredient comprising an ingredient selected from the group consisting of a solid alkaline neutralizing agent, an aluminosilicate, and mixtures thereof.

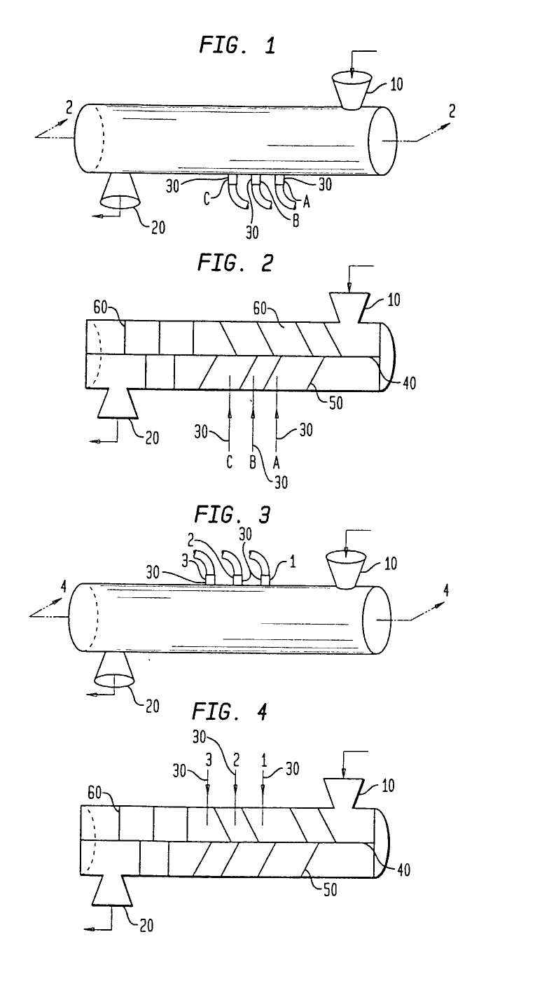

### FIELD OF THE INVENTION

The present invention relates to cleaning compositions in the form of tablets.

### BACKGROUND OF THE INVENTION

Detergent compositions in tablet form and intended for fabric washing machine or dishwashing are sold commercially. Tablets have several advantages over powdered products: they do not require measuring and are thus easier to handle and dispense into the washload, and they are more compact, hence facilitating more economical storage.

Tablets of a cleaning composition are generally made by compressing or compacting a composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tableting will often be carried out with enough pressure to achieve a compromise between these desirable but antagonistic properties. However, it remains desirable to improve one or other of these properties without detriment to the other so as to improve the overall compromise.

If a tablet contains organic surfactant, this functions as a binder, plasticising the tablet. However, it can also retard disintegration of the tablet by forming a viscous gel when the tablet comes into contact with water. Thus, the presence of surfactant can make it more difficult to achieve both good strength and speed of disintegration: the problem has proved especially acute with tablets formed by compressing powders containing surfactant and built with insoluble detergency builder such as sodium aluminosilicate (zeolite). Appel et al. (U.S. Pat. Nos. 5,133,924, 5,164,108 and 5,282,996) and Bortolotti et al. (U.S. Pat. No. 5,160,657) describe a non-spray drying process of making detergent granules, including possible in situ neutralization of an anionic surfactant precursor. WO 99/00475 describes adding some inorganic acid together with the liquid acid precursor of the anionic surfactant, and a solid neutralizing agent in order to obtain a lower bulk density product. WO 00/37605 discloses a process in which an organic (non-surfactant) acid is used in combination with a carbonated neutralising agent to provide products with bulk densities below about 600 g/l. U.S. Pat. No. 6,162,784 (Hall et al.) discloses mixing a detergent surfactant and an acid source with an alkaline source to improve the suitability and/or dispersion of the detergent in the laundering solution. Organic or inorganic acid may be used; examples of alkaline source are said to include carbonate or silicate.

Janssen (U.S. Pat. No. 6,310,028) discloses a process for making detergent granules (which are eventually used for making detergent tablets). The process may include neutralization of acetic acid with sodium carbonate in a mixer/granulator, to produce sodium acetate dihydrate or trihydrate, which is a suitable tablet disintegrant aid.

Addison (U.S. Pat. No. 6,274,538) discloses tablets which are dispersed by means of gas entrapped within detergent ingredients which gas may be formed by including acid and alkyl within the detergent granule which react upon the contact with water to produce a gas. Gordon (EP 0 838 519 and U.S. Pat. No. 6,093,688), Lammers et al. (U.S. Pat. No. 6,242,403) and Janssen (U.S. Pat. No. 6,310,028) disclosed various detergent tablets containing sodium acetate. WO 01/10995 discloses co-granules of acetate and carbonate for use in the detergent tablets.

### SUMMARY OF THE INVENTION

The present invention includes detergent tablet comprising:

from about 80% to about 100%, by weight of the tablet, of detergent granules, the granules comprising

(a) from about 5% to about 30%, by weight of the granules, of an anionic surfactant;

(b) from about 2% to about 15%, by weight of the granules, of acetic acid salt;

(c) from about 50% to about 80%, by weight of the granules, of a solid ingredient comprising an ingredient selected from the group consisting of a solid alkaline neutralizining agent, an aluminosilicate, and mixtures thereof.

Due to the beneficial granule properties obtained by the inventive process (easily compactable, yet not too sticky), it was possible to reduce compaction forces drastically, which in turn produced a more porous tablet, leading to strong tablets having a satisfactory dissolution in washing machine. Furthermore, by virtue of employing the inventive process for making tablets, the need for post-dosing acetate or carbonate is significantly reduced or eliminated.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight of the detergent granule, unless otherwise specified.

It should be noted that in specifying any range of concentration, any particular upper concentration can be associated with any particular lower concentration.

For the avoidance of doubt the word “comprising” is intended to mean “including” but not necessarily “consisting of” or “composed of.” In other words, the listed steps or options need not be exhaustive.

“Liquid” as used herein means that a continuous phase or predominant part of the composition or of the ingredient is liquid and that a composition or an ingredient is flowable at 20° C. (i.e., suspended solids may be included).

“Caustic Solution” means a 40-60%, preferably 50%, (wt/wt) aqueous solution of sodium or potassium hydroxide. Sodium or potassium hydroxide do not fall within “solid ingredients” definition herein.

“Acetate” or “Acetic Acid Salt” and its amounts described herein include non-hydrated, partially hydrated and fully hydrated forms of the salt.

### ANIONIC NON-SOAP SURFACTANT

Essentially any anionic non-soap surfactant is suitable. Preferably, in the process of making the inventive tablets, the anionic surfactant is obtained by an in situ neutralization of an anionic surfactant precursor acid.

The liquid acid precursor of an anionic surfactant may be selected from linear alkyl benzene sulphonic acids, alpha-olefin sulphonic acids, internal olefin sulphonic acids, fatty acid ester sulphonic acids and combination thereof, as well as the acid precursors of alkyl ether sulphates. In all cases, these materials preferably have on average in the aliphatic moiety thereof, from 8 to 24 carbon atoms. The inventive tablets preferably comprise alkyl benzene suphonates.

Preferred alkylbenzene sulfonates useful in the inventive tablets include those with an alkyl portion which is straight chain or branched chain, preferably having from 10 to 18, most preferably 10 to 16 carbon atoms. Alkylbenzene sulfonates with a predominantly straight chain are preferred because they are more easily biodegraded.

Another preferred class of anionic surfactants are primary or secondary alkyl sulphates. These surfactants can be obtained by sulphation of the corresponding primary or secondary alcohols, followed by neutralization.

Preferred alkyl sulfates include those with an alkyl portion which is straight chain or branched chain, preferably having from about 8 to about 24 carbon atoms, more preferably from about 10 to about 20 carbon atoms, more preferably still from about 12 to about 18 carbon atoms. The alkyl chains of the alkyl sulfates preferably have an average chain length of from about 14 to about 16 carbon atoms. The alkyl chains are preferably linear.

The anionic surfactants useful in the subject invention process may also be combinations of alkylbenzene sulfonates and alkyl sulfates, whether mixed together or added separately. Combinations having a ratio of alkylbenzene sulfonate to alkyl sulfate of from about 20:80 to about 80:20 are preferred; those having a ratio of from about 40:60 to about 69:40 are more preferred.

The amount of anionic surfactant employed in the inventive tablets is from 5% to 30%, preferably from 10% to 20%, most preferably, in order to attain detergent granules having optimum stickiness and disintegration, from 10 to 18%.

### ACETIC ACID SALT

Suitable acetates include but are not limited to inorganic acetate salts, especially sodium and/or potassim acetate. Sodium acetate is especially preferred.

The amount of acetate is generally in the range of from 2 to 15%. Preferably, in order to minimize excessive stickiness, yet not to have granules that are too dry, the amount is in the range of from 3 to 12% most preferably from 4 to 10%, in order to obtain granules that are neither too sticky nor too dry.

Preferably, the acetate included in the detergent granules is in situ neutralized acetate, neutralized during the process of making detergent granules. The in situ formation of the acetate according to the preferred embodiment of present invention is advantageous for the production of tablets since in the typical production of tablets employing acetate (typically, sodium acetate) as a disintegrant, the bulk of the acetate is added in a separate post-dosing step (after the processing in a high-speed and a moderate speed mixer).

Sodium acetate, however, is difficult to handle on a commercial scale due to dust generation and caking. On the other hand, when bulk pre-neutralised sodium acetate salt is added to a mixer (instead of being post-dosed), it results in too high solids to liquids ratio, so that no other solids, e.g. carbonate, can be added within the mixer.

The in-situ formed acetate in the inventive tablets avoids the bulk acetate handling problems of the post-dosing step and maximizes the tablet making efficiency. Furthermore, by virtue of employing liquid acetic acid and liquid caustic, increased amounts of carbonate may be added within the mixer, thus minimising or even eliminating the need for post-dosing of carbonate as well as post-dosing acetate.

In addition, the in situ formed acetate attains detergent granule that are easily compactable, yet not too sticky, leading to optimum tablet properties (strength and dissolution).

### ADDITIONAL SOLID INGREDIENTS

A solid alkaline neutralizing agent is preferably present, especially when the anionic surfactant and the acetate are formed by in situ neutralization, to ensure complete neutralization and to provide the solid bulk. The preferred solid alkaline neutralizing agent is carbonate, because it also functions as a builder, in particular soda ash and, especially preferred is light soda ash (synthetic) or mined soda ash or dense soda ash, to optimize detergent granule properties. Other suitable alkaline neutralizing agents include but are not limited to bicarbonate, sesquicarbonates, burkeite and mixtures thereof. If the alkaline neutralizing agent is also capable of being a builder, it is preferably present in excess, so that it is not all used up in neutralization, but some remains to serve as a builder in the detergent granules.

The solid alkaline neutralizing agent is generally included in the range of from 10 to 50%, preferably from 20 to 40% and, most preferably, in order to achieve full neutralization and to have sufficient excess to function as a builder, from 25 to 40%. Another preferred solid starting ingredient is aluminosilicate, e.g. zeolite. Crystalline and amorphous aluminosilicate are suitable as well as mixed crystalline and amorphous aluminosilicate and layered silicates. The zeolite used in most commercial particulate detergent compositions is zeolite A. Advantageously, however, maximum aluminum-zeolite P (zeolite MAP may be used as described in claims U.S. Pat. Nos. 5,374,370 and 5,512,266 incorporated by reference herein). Zeolite MAP is an alkyl metal aluminosilicate of the P type having a silicone to aluminum ratio not exceeding 1.5 preferably not exceeding 1.33 and more preferably not exceeding 1.07. Aluminosilicate is generally included in an amount of from 5 to 50%, preferably from 10 to 40% and most preferably in order to provide sufficient solids and the builder function, from 20 to 40%.

Other solid starting ingredients may be present, including for example, organic or inorganic builders.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts. A copolymer of maleic acid, acrylic acid and vinyl acetate is especially preferred as it is biodegradable and thus environmentally desirable. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %. Citrates can also be used at lower levels (e.g. 0.1 to 5 wt %) for other purposes. The builder is preferably present in alkali metal salt, especially sodium salt form.

The total of solid ingredients is in the range from 50 to 80% preferably from 60 to 75% and most preferably in order to attain optimum granulation from 65 to 70%.

### OPTIONAL ADDITIONAL INGREDIENTS IN THE DETERGENT GRANULE

Preferably, the detergent granule further includes a nonionic surfactant, generally in an amount from 1 to 15%, preferably, in order to attain optimum binding of the ingredients in the granule, from 2 to 10%, most preferably from 3 to 8%. Preferably, the nonionic surfactant is liquid, so that it does serve as an additional binder in the granule formation.

As is well known, the nonionic surfactants are characterized by the presence of a hydrophobic group and an organic hydrophilic group and are typically produced by the condensation of an organic aliphatic or alkyl aromatic hydrophobic compound with ethylene oxide (hydrophilic in nature). Typical suitable nonionic surfactants are those disclosed in U.S. Pat. Nos. 4,316,812 and 3,630,929, incorporated by reference herein.

Usually, the nonionic surfactants are polyalkoxylated lipophiles wherein the desired hydrophile-lipophile balance is obtained from addition of a hydrophilic poly-lower alkoxy group to a lipophilic moiety. A preferred class of nonionic detergent is the alkoxylated alkanols wherein the alkanol is of 9 to 20 carbon atoms and wherein the number of moles of alkylene oxide (of 2 or 3 carbon atoms) is from 3 to 20. Of such materials it is preferred to employ those wherein the alkanol is a fatty alcohol of 9 to 11 or 12 to 15 carbon atoms and which contain from 5 to 8 or 5 to 9 alkoxy groups per mole. Also preferred is paraffin-based alcohol (e.g. nonionics from Huntsman or Sassol).

Exemplary of such compounds are those wherein the alkanol is of 10 to 15 carbon atoms and which contain about 3 to 12 ethylene oxide groups per mole, e.g. Neodol® 25-9 and Neodol® 23-6.5, which products are made by Shell Chemical Company, Inc. The former is a condensation product of a mixture of higher fatty alcohols averaging about 12 to 15 carbon atoms, with about 9 moles of ethylene oxide and the latter is a corresponding mixture wherein the carbon atoms content of the higher fatty alcohol is 12 to 13 and the number of ethylene oxide groups present averages about 6.5. The higher alcohols are primary alkanols.

Another subclass of alkoxylated surfactants which can be used contain a precise alkyl chain length rather than an alkyl chain distribution of the alkoxylated surfactants described above. Typically, these are referred to as narrow range alkoxylates. Examples of these include the Neodol-1 ® series of surfactants manufactured by Shell Chemical Company.

Other useful nonionics are represented by the commercially well-known class of nonionics sold under the trademark Plurafac® by BASF. The Plurafacs® are the reaction products of a higher linear alcohol and a mixture of ethylene and propylene oxides, containing a mixed chain of ethylene oxide and propylene oxide, terminated by a hydroxyl group. Examples include C₁₃-C₁₅ fatty alcohol condensed with 6 moles ethylene oxide and 3 moles propylene oxide, C₁₃-C₁₅ fatty alcohol condensed with 7 moles propylene oxide and 4 moles ethylene oxide, C₁₃-C₁₅ fatty alcohol condensed with moles propylene oxide and 10 moles ethylene oxide or mixtures of any of the above.

Another group of liquid nonionics are commercially available from Shell Chemical Company, Inc. under the Dobanol® or Neodol® trademark: Dobanol® 91-5 is an ethoxylated C₉-C₁₁ fatty alcohol with an average of 5 moles ethylene oxide and Dobanol® 25-7 is an ethoxylated C₁₂-C₁₅ fatty alcohol with an average of 7 moles ethylene oxide per mole of fatty alcohol.

In the tablets of this invention, preferred nonionic surfactants include the C₁₂-C₁₅ primary fatty alcohols or alkyl phenols with relatively narrow contents of ethylene oxide in the range of from about 6 to 9 moles, and the C₉ to C₁₁ fatty alcohols ethoxylated with about 5-6 moles ethylene oxide.

Another class of nonionic surfactants which can be used in accordance with this invention are glycoside surfactants. Glycoside surfactants suitable for use in accordance with the present invention include those of the formula:

RO—(R¹O)_{y}—(Z)ₓ

wherein R is a monovalent organic radical containing from about 6 to about 30 (preferably from about 8 to about 18) carbon atoms; R¹ is a divalent hydrocarbon radical containing from about 2 to 4 carbons atoms; O is an oxygen atom; y is a number which can have an average value of from 0 to about 12 but which is most preferably zero; Z is a moiety derived from a reducing saccharide containing 5 or 6 carbon atoms; and x is a number having an average value of from 1 to about 10 (preferably from about 1½ to about 10).

A particularly preferred group of glycoside surfactants for use in the practice of this invention includes those of the formula above in which R is a monovalent organic radical (linear or branched) containing from about 6 to about 18 (especially from about 8 to about 18) carbon atoms; y is zero; z is glucose or a moiety derived therefrom; x is a number having an average value of from 1 to about 4 (preferably from about 1½ to 4). Nonionic surfactants which may be used include polyhydroxy amides as discussed in U.S. Pat. No. 5,312,954 to Letton et al., and aldobionamides such as disclosed in U.S. Pat. No. 5,389,279 to Au et al., both of which are hereby incorporated by reference into the subject application.

Mixtures of two or more of the nonionic surfactants can be used.

The weight ratio of anionic surfactant(s) to any optional nonionic surfactants, will normally be from 20:1 to 1:20. However, this ratio may be, for example, 15:1 or less, 10:1 or less, or 5:1 or less. Ratios in the range from 5:1 to 2:1 of anionic surfactant(s) to nonionic surfactants(s) are preferred.

Another preferred optional ingredient is soap or a fatty acid which upon in-situ neutralization becomes soap. Suitable fatty acids have the chain lengths of from 10 to 18 carbon atoms, with the preferred fatty acid being stearic acid, generally employed in an amount of from 0.1 to 10%, preferably from 0.5 to 7%, most preferably from 0.5 to 5%. In the most preferred embodiment stearic acid is premixed with nonionic surfactant, to attain the most uniform mixing in the mixer.

Typically, the amounts of pre-neutralized acids included in the starting ingredients is below 10%, most preferably below 5% and, optimally, below 2% by weight of the starting ingredient.

Another preferred ingredient in the granule is sodium carboxymethyl cellulose, an anti-redeposition agent, typically included in the range of from 0 to 5%, preferably from 0 to 3%.

### DETERGENT GRANULE AMOUNT

The inventive tablets preferably include at least 80% of the detergent granules, by weight of the tablet, preferably from 82% to 97%, more preferably from 87% to 97%, most preferably from 94% to 97% (the need for post-dosing acetate and carbonate being virtually eliminated by the inventive process).

### OPTIONAL POST-DOSED INGREDIENTS

In the tablets of the present invention, sodium carboxymethylcellulose is preferably added as the post-dosed ingredient, separate from detergent granules, to attain optimum tablet disintegration. The amount of post-dosed sodium carboxymethylcellulose is generally in the range of from 0 to 10%, by weight of the finished tablet composition, preferably from 0 to 8%, most preferably from 0 to 5%.

The inclusion into the detergent granules in situ neutralized sodium acetate which, in turn, acts as a disintegrant in the detergent tablet is preferred, in order to avoid or minimize post-dosed acetate and/or carbonate. The preferred tablets according to the present invention do not employ any substantial amounts of additional sodium acetate as the post-dosed ingredient. Furthermore, in the preferred tablets, no additional carbonate is post-dosed. Specifically, in the preferred tablets at least 90% of all sodium acetate and/or carbonate present in the tablets is present in the detergent granules formed in a high speed mixer, preferably at least 95% and most preferably at least 98%. The amount of post-dosed acetate and/or carbonate in the preferred tablets is less than 15%, by weigh of the tablet, preferably no more than 10%, most preferably below 10%, optimally in the range of 0-5%. In the most preferred tablets according to the present invention, substantially no additional disintegrant is added in a post-dosing steps even if the disintegrant is other than acetate. Surprisingly, the disintegration of the resulting tablets, especially aged tablets, is optimised if, in addition to the in-situ formed acetate, the inventive tablets includes post-dosed sodium carboxymethylcellulose, as described above.

Additional post-dosed ingredients may be included, especially ingredients that are not ideally suitable for processing in the high speed mixer, e.g. enzymes, bleaches, bleach precursors, fragrances, additional zeolite.

### PROCESS OF MAKING DETERGENT GRANULES

The detergent granules may be made by any process known in the art, but are preferably made by a process employing a high speed mixer for making detergent granules. The process may be continuous or batch. Suitable high mixers provide a high energy stirring input and achieve thorough mixing in a very short time. The preferred high speed mixer is Lodige CB30 or Lodige CB100 (commonly known as Recycler). Other types of high-speed mixers having a comparable effect on detergent powders can be also contemplated. For instance a Shugi (Trade Mark) Granulator or a Drais (Trade Mark) K-TTP 80 may be used.

The high speed mixer essentially consists of a large, static horizontal cylinder. In the middle, it has a rotating shaft along the horizontal axis with various blades and mixing tools mounted thereon. The mixer is designed to quickly and effectively combine liquid and solid ingredients. It can be rotated at tip speeds between 100 and 2500 rpm, dependent on the degree of mixing and the particle size desired. The blades and tools on the shaft provide a thorough mixing action of the solids and the liquids.

The mean residence time in the high speed mixer is somewhat dependent on the rotational speed of the shaft, the position of the blades and other process parameters. The typical residence time is from about 1 second to about 1 minute, preferably from about 5 seconds to about 45 seconds, most preferably to achieve effective mixing at optimum energy input from 5 to 30 seconds.

In a high speed mixer, the solid starting material is typically input through funnel (the solid falling by gravity), whereas liquids are dosed through nozzles with the direction of the flow typically from the funnel towards the nozzles and eventually towards the exit opening, equipped e.g. with a reverse hopper to collect the granules. Typically, at least three nozzles are present for dosing liquids, preferably at least three. In the preferred embodiment the nozzles are equipped with additional spray nozzles. In the preferred embodiment, the liquid dosing nozzles are positioned at the top of the mixer, to obtain optimum neutralization reaction speed and optimum granulation process and detergent granule properties. In an even more preferred embodiment of the present invention, the first nozzle (i.e., closest to the funnel) is utilized for caustic solution, the second nozzle is utilized for nonionic or, more preferably, nonionic/stearic acid mixture, the third nozzle (i.e., most distant from the funnel) is utilized for anionic surfactant precursor/acetic acid. More than three total nozzles may be present, but in any event, this order of addition relative to the solids input is preferably followed. The input of liquid starting ingredient in such an order with respect to the direction of the solid material flow optimizes the granulation process. The inputting of both solid and liquid starting materials from the top of the mixer prevents accumulation of the material upstream because neutralization of liquid non-surfactant organic acid occurs almost immediately. If acetic acid is fed through the bottom of the mixer and, especially, through the nozzle closest to the funnel, it may accumulate too much solid (due to the fast neutralization reaction) upstream of the liquid injection nozzles and cause instability of the mixer power (power draw oscillation) which may result in the shut-down of the mixer. According to the most preferred embodiment of the present invention, acetic acid is pre-mixed with anionic surfactant acid precursor, to ensure the best distribution of both the surfactant and the in-situ formed acetate in the detergent granules.

The amount of acetic acid employed in making the inventive tablets is from 1 to 9%, preferably in order to attain tablets with optimum disintegration at a minimum of post-dosed acetate, from 4 to 8 %, more preferably at least 5%.

Due to a relatively short residence time in the mixer and due to the fact that large amounts of total liquid acid are present (the anionic surfactant precursor acid and the liquid organic non-surfactant acid), a liquid caustic is preferably employed in the present invention in order to ensure that the neutralization occurs to the full extent, within the relatively short amount of time available in the mixer. Under-neutralization of the acetic acid, leads to vinegar odor. To ensure that the neutralization takes place to the full extent, it is preferred to employ a liquid caustic, since the liquid caustic/liquid acid neutralization reaction occurs faster than solid alkali/liquid acid neutralization reaction.

Essentially any caustic solution is suitable for use in the present invention. The preferred caustic solution, due to its commercial availability, is a 50% wt./wt. sodium hydroxide solution.

The amount of the liquid caustic employed in the present invention depends on the total amounts of the acids (surfactant precursor and organic non-surfactant) that are employed and is generally in the range of from 0.5 to 5%, preferably from 1 to 3%, most preferably from 1 to 2%, by weight of starting ingredients.

Traditionally, increasing solids to liquid surfactant ratio in a high speed mixer was problematic because the process is too fast and the resulting granules are too fine. By virtue of employing a liquid organic non-surfactant acid in the preferred embodiment of the invention, the solids level can be increased. The starting solids to the starting liquid surfactant weight ratio in the inventive process is generally in the range of from 1:1 to 6:1, preferably from 1:1 to 5:1, most preferably in order to optimize the process and to produce granules that are neither too fine nor too sticky, from 2:1 to 5:1. For calculating this ratio, “surfactant” includes all liquid synthetic non-soap surfactants and precursors thereof (so includes nonionic surfactants, if any, anionic surfactant precursor but not stearic acid or sodium stearate).

In the preferred embodiment of the inventive process, the detergent granules resulting from the mixing in a high speed mixer, are fed into a second mixer, preferably a moderate speed mixer, most preferably Lodige KM300 mixer or Lodige KM 10000 or Lodige 13500, also referred as Lodige Ploughshare. Such mixers are equipped with mixing shaft with “plough” blades and choppers. The granules exiting from the second mixer may be dried or further processed in a fluid bed apparatus or in an air lift, various ingredients may be sprayed onto the granules in fluid bed apparatus.

A layering agent may be employed (e.g. silicate, aluminosilicate or other fine powder) between the mixers or in the second mixer or after the granules exit from first or the second mixer.

In one preferred embodiment, especially suitable for continuous processes, oversized granules and/or fines are recycled and fed to the high speed mixer along with the starting ingredients.

### TABLETING

The detergent granules granules resulting from the high speed mixer and optionally moderate speed mixer and fluid bed dryer, may be optionally be post-dosed with additional ingredients and then compressed into tablets.

Tableting entails compaction of a particulate composition. A variety of tableting machinery is known, and can be used. Generally it will function by stamping a quantity of the particulate composition which is confined in a die.

By virtue of employing the detergent granules containing in situ neutralized acetate, tablets may be made using lower compaction pressures. In general, a tension exists in tablet manufacture between compaction pressure and optimum tablet solubility: sufficient compaction pressure must be used to provide a tablet which does not break easily during transportation and in handling, yet the tablet must not be so strongly compacted as not to dissolve sufficiently early in the laundry cycle. In the inventive tablets, due to the unique properties of the detergent granules, the granules compact easily (so, lower compaction pressure may be used), yet the tablet is both non-friable and dissolves satisfactorily in the laundry process. Although any suitable compaction pressure may be used, preferably, in order to obtain a tablet which is non-friable in storage and in handling, yet dissolves early enough in the washing machine, the compaction pressure is in the range of from 0.3 to 2.0 Bars (at 1 atmosphere), preferably from 0.3 to 1.5 Bars, most preferably, from 0.3 to 1.0 Bars. These compaction forces arc associated with tablet strength and dissolution times as follows: the dissolution times (measured as described in the Examples below) are in the range of 1 to 5 minutes, preferably from 1 to 4 and most preferably from 1 to 3 minutes; The tablet strength (measured as described in the Examples below) is in the range of 15 to 60 Newton, preferably from 15 to 40 Newton and more preferably from 20 to 30 Newton.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

If any heat is supplied, it is envisaged that this will be supplied conventionally, such as by passing the particulate composition through an oven, rather than by any application of microwave energy.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids.

Tableted detergent compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate; and perbenzoic acid precursors. The quaternary ammonium and phosphonium bleach activators disclosed in U.S. Pat. Nos. 4,751,015 and 4,818,426 (Lever Brothers Company) are also of interest. Another type of bleach activator which may be used, but which is not a bleach precursor, is a transmition metal catalyst as disclosed in EP-A-458397, EP-A-458398 and EP-A-0549272. A bleach system may also include a bleach stabiliser (heavy metal sequestrant) such as ethylenediamine tetramethylene phosphonate and diethylenetriamine pentamethylene phosphonate.

As indicated above, if a bleach is present and is a water-soluble inorganic peroxygen bleach, the amount may well be from 10% to 25% by weight of the composition.

### Other Ingredients.

The detergent tablets of the invention may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N.V., Delft, Holland, and Alcalase (Trade Mark) and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

The detergent tablets of the invention may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenylstyryl) disulphonate.

An antifoam material is advantageously included, especially if the detergent tablet is primarily intended for use in front-loading drum-type automatic washing machines. Suitable antifoam materials are usually ingranular form, such as those described in EP 266863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition.

It may also be desirable that a detergent tablet of the invention includes an amount of an alkali metal silicate, particularly sodium ortho-, meta- or preferably alkali metal silicates at levels, for example, of 0.1 to 10 wt %, may be advantageous in providing protection against the corrosion of metal parts in washing machines, besides providing some measure of building and giving processing benefits.

Further ingredients which can optionally be employed in the detergent tablet of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

The invention may be embodied as tablets for machine dishwashing. Such tablets typically contain a high proportion of water soluble salts, such as 50 to 95% by weight, at least some of which, exemplified by sodium citrate and sodium silicate, have water-softening properties.

Bactericides, e.g. tetrachlorosalicylanilide and hexachlorophene, fungicides, dyes, pigments (water dispersible), preservatives, e.g. formalin, ultraviolet absorbers, anti-yellowing agents, such as sodium carboxymethyl cellulose, pH modifiers and pH buffers, color safe bleaches, perfume and dyes and bluing agents such as Iragon Blue L2D, Detergent Blue 472/372 and ultramarine blue can be used.

Also, cationic softening agents may be used.

The list of optional ingredients above is not intended to be exhaustive and other optional ingredients which may not be listed, but are well known in the art, may also be included in the composition.

The following specific examples further illustrate the invention, but the invention is not limited thereto.

The following ingredients have been used in the Examples:

Linear Alkylbenzene Sulfonic Acid Alkylbenzene sulfonic acid which is predominantly

straight chain 10 to 16 carbon atoms (“LAS”),

Na LAS: Sodium salt of Linear Alkylbenzene Sulfonic Acid

Glacial Acetic Acid (“HOAC”)

Sodium Hydroxide Caustic Solution (“NAOH”)

Nonionic: Dobanol® 25-7 is an ethoxylated C₁₂-C₁₅ fatty alcohol with an average of 7 moles ethylene oxide per mole of fatty alcohol.

Sodium Carboxymethyl Cellulose (“SCMC”)

Stearic Acid (“Stearic”)

Na stearate: Sodium stearate

Soda Ash: mined Sodium Carbonate

Zeolite A24 (“Zeolite”)

### EXAMPLES 1-10

TABLE I
STARTING INGREDIENTS

| | % by weight of starting ingredients | | | | | | | | | |
|---|---|---|---|---|---|---|---|---|---|---|
| Example | | | | Non | | | Soda | | Miscellaneous | Solid/Liquid |
| Number | LAS | HOAc | NaOH | Ionic | SCMC | Stearic | Ash | Zeolite | & water | Surfactant ratio |
| Example 1 | 13.1 | 5.1 | 1.1 | 4.5 | 1.5 | 1.0 | 48.5 | 20.0 | 5.2 | 3.98 |
| Example 2 | 18.0 | 7.8 | 1.5 | 5.6 | 2.2 | 1.5 | 11.1 | 43.0 | 9.3 | 2.39 |
| Example 3 | 17.5 | 7.8 | 1.4 | 5.4 | 2.2 | 1.3 | 12.2 | 43.0 | 9.2 | 2.51 |
| Example 4 | 13.1 | 5.1 | 1.1 | 4.5 | 1.5 | 1.0 | 43.0 | 25.0 | 5.7 | 3.95 |
| Example 5 | 15.6 | 5.1 | 1.1 | 4.5 | 1.7 | 0.9 | 34.4 | 30.0 | 6.7 | 3.29 |
| Example 6 | 14.8 | 5.1 | 1.3 | 4.3 | 1.6 | 0.9 | 35.3 | 31.0 | 5.7 | 3.55 |
| Example 7 | 14.7 | 5.1 | 1.3 | 4.3 | 1.6 | 0.9 | 35.3 | 31.0 | 5.8 | 3.57 |
| Example 8 | 14.7 | 5.1 | 1.5 | 4.3 | 1.6 | 0.9 | 35.3 | 31.0 | 5.6 | 3.57 |
| Example 9 | 14.6 | 5.9 | 1.6 | 4.5 | 1.6 | 0.9 | 34.0 | 30.0 | 6.9 | 3.43 |
| Example 10 | 14.6 | 5.9 | 1.6 | 4.5 | 1.6 | 0.9 | 34.1 | 29.8 | 7.0 | 3.43 |

TABLE 2
PROCESS CONDITIONS
Lodige CB30 Recycler was used. In Examples 1-3 the liquids were fed
from the bottom of the mixer; in Examples 4-10 liquids were fed from
the top of the mixer. In Examples 8-10, fines were recycled.

| | | Recycler | Mass flow |
|---|---|---|---|
| Example | Recycler | power draw | Rate |
| Number | rpms | (kw) | (kg/hour) |
| Example 1 | 1500 | 9.0-25.0 | 682 |
| Example 2 | 1500 | 9.0-25.0 | 545 |
| Example 3 | 1500 | 9.0-25.0 | 545 |
| Example 4 | 1500 | 8.0-12.0 | 682 |
| Example 5 | 1730 | 7.0-12.0 | 755 |
| Example 6 | 1730 | 6.0-8.0 | 755 |
| Example 7 | 1730 | 5.0-8.0 | 755 |
| Example 8 | 1730 | 5.0-7.0 | 755 |
| Example 9 | 1730 | 8.0-11.0 | 755 |
| Example 10 | 1730 | 6.0-8.0 | 755 |

It can be seen from Table 2 that the power draw oscillation was within substantially more narrow range in Examples 4-10 when the liquids were fed from the top of the mixer compared to Examples 1-3 when the liquids were fed from the bottom of the mixer.

TABLE 3
GRANULE COMPOSITION

| Exam- | | In Situ | | | Na | | | Miscel- |
|---|---|---|---|---|---|---|---|---|
| ple | Na | Na | Non | | Stea- | Soda | Zeo- | laneous |
| Number | LAS | Acetate | Ionic | SCMC | rate | Ash | lite | & water |
| Exam- | 13.50 | 6.3 | 4.50 | 1.01 | 1.08 | 48.50 | 20.00 | 5.11 |
| ple 1 | | | | | | | | |
| Exam- | 18.50 | 7.2 | 5.55 | 1.40 | 1.63 | 11.70 | 43.00 | 11.02 |
| ple 2 | | | | | | | | |
| Exam- | 18.00 | 7.5 | 5.40 | 1.40 | 1.41 | 12.60 | 43.00 | 10.69 |
| ple 3 | | | | | | | | |
| Exam- | 13.50 | 6.3 | 4.50 | 1.00 | 1.10 | 43.00 | 25.00 | 5.60 |
| ple 4 | | | | | | | | |
| Exam- | 16.00 | 5.8 | 4.50 | 1.10 | 1.08 | 34.40 | 30.00 | 7.12 |
| ple 5 | | | | | | | | |
| Exam- | 15.10 | 6.4 | 4.30 | 1.10 | 1.08 | 35.30 | 31.00 | 5.72 |
| ple 6 | | | | | | | | |
| Exam- | 15.10 | 6.3 | 4.30 | 1.10 | 1.08 | 35.30 | 31.00 | 5.82 |
| ple 7 | | | | | | | | |
| Exam- | 15.10 | 6.3 | 4.30 | 1.10 | 1.08 | 25.30 | 31.00 | 15.82 |
| ple 8 | | | | | | | | |
| Exam- | 15.00 | 7 | 4.50 | 1.10 | 1.08 | 30.00 | 34.00 | 7.32 |
| ple 9 | | | | | | | | |
| Exam- | 15.00 | 7 | 4.50 | 1.10 | 1.08 | 30.00 | 34.10 | 7.22 |
| ple 10 | | | | | | | | |

### EXAMPLES 11-16

Tablets were made using granules produced by Examples 5-10, with granule compositions detailed in Table 3. The granules were fed to Ploughshare (ex. Lodige), conditioned in a fluid bed, the resulting granules named “Base Powder” in the Tables below, additional ingredients were post-dosed—mixed with the Base Powder. Portions of 36 to 40 g of the compositions were made into cylindrical tablets with a diameter of 44 mm and a height between 21 to 25 mm, using a Grasby Specac labscale tablet press with varying compaction forces. The strength of the tablets was determined by the force, expressed in Newtons, needed to break the tablet, as measured by MTS Synergie 100 testing instrument.

The speed of dissolution of the tablets was measured by a test procedure in which a tablet is placed on a plastic sieve with 2 mm mesh size which was immersed in 9 liters of tap water at 20C and rotated at 200 rpms. The water conductivity was monitor over a period of about 5 to 10 minutes or until it reach a constant value. The time for break up and dissolution of the tablet t90 was taken as the time for change of the water conductivity to reach 90% of its final value. This was also confirmed by visual observation of material remaining on the rotating sieve.

The results that were obtained are summarized in Table 4.

TABLE 4

| Example Number | 11A | 11B | 11C | 12 | 13 | 15 | 16 |
|---|---|---|---|---|---|---|---|
| Base Powder | 5 | 5 | 5 | 6 | 7 | 9 | 10 |
| Composition Example | | | | | | | |
| No. | | | | | | | |
| In situ Sodium Acetate | 5.97 | 5.97 | 6.90 | 6.51 | 6.36 | 6.96 | 6.96 |
| (by weight of tablet) | | | | | | | |
| | % by weight of the tablet | | | | | | |
| Base Powder | 85.4 | 85.4 | 98.5 | 93.1 | 90.9 | 87 | 87 |
| Post-Dosed Ingredients | | | | | | | |
| Sodium Carbonate | 0.0 | 6.5 | 0.0 | 0.0 | 0.0 | 0.0 | 0.0 |
| Sodium Acetate | 13.1 | 6.6 | 0.0 | 5.1 | 7.3 | 10 | 10 |
| Sodium Perborate | 1.0 | 1.0 | 1.0 | 1.0 | 1.0 | 1.0 | 1.0 |
| Fragrance | 0.0 | 0.0 | 0.0 | 0.3 | 0.3 | 0.3 | 0.30 |
| Zeolite | 0.5 | 0.5 | 0.5 | 0.5 | 0.5 | 0.5 | 0.5 |
| Fluorescer | 0 | 0 | 0 | 0 | 0 | 0.23 | 0'.23 |
| Tablet strength (N) | 34.8 | 30.3 | 27.3 | 40.0 | 29.0 | 24 | 23.3 |
| Compaction Force | 2.0 | 2.5 | 1.5 | 2 | 1.5 | 0.75 | 0.8 |
| (bars) | | | | | | | |
| T90 (minutes) | 2.08 | 2.34 | 6.39 | 5.11 | 2.49 | 2.36 | 2.37 |
| Tablet Weight (g) | 38.0 | 38.0 | 38.0 | 37.0 | 37 | 38.0 | 38.0 |

In example 14, base powder granules of Example 8 were used to make a tablet. Tablets made with this base powder did not dissolve well. In Examples 14-16, fines from the fluid bed were recycled to the recycler, in the base powder production. It appears that the base powder in Example 14, at the ploughshare stage, was over-worked due to the loss of layering zeolite resulting from the high dust collection suction. Overworked powder results in high t90. This was resolved in successive runs (by closing to some extent the dust collection vent).

The results in Table 4 indicate that reducing the amount of post-dosed sodium acetate and post-dosed carbonate was possible (Example 11B vs. Example 11A; also, Examples 12, 13, 15 and 16). Compaction forces were not as high as with typically employed in the past (typical compaction force is 2.5-3 bars).

Due to the better control of the granulation process with in-situ neutralized sodium acetate, power draw oscillations in the recycler were less which give better and more consistent granules. Due to the beneficial granule properties (easily compactable, yet not too sticky), it was possible to reduce compaction forces drastically, which in turn produced a more porous tablet. The more porous the faster the water ingress into the tablet, leading to faster dissolution. Yet, the tablet strength was in a satisfactory ( above 20 Newtons) range.

### EXAMPLE 17

Example 11 was repeated, but using a blend of base powder granules of Examples 9 and 10. The results that were obtained are summarized in Table 5

TABLE 5

| | % by weight of |
|---|---|
| Tablet Formulation | the tablet |
| Base Powder | 94.7 |
| Sodium Carbonate | 0.0 |
| Sodium Acetate | 0.0 |
| Fragrance | 0.3 |
| Zeolite | 1.0 |
| Fluorescer | 0.2 |
| SCMC | 3.0 |
| Miscellaneous | 0.8 |
| Total | 100.0 |
| Compaction force (bars) | 0.4 |
| Tablet strength (N) | 26.1 |
| T90 (minutes) | 2.5 |
| T90 (minutes) of 3 days | 3.7 |
| old tablet | |
| Tablet Weight, g | 36.0 |

It can be seen from Table 5, that the inventive process resulted in granules which could be compacted using a very low compaction force and having satisfactory tablet strength and dissolution, even after aging, even in the complete absence of post-dosed sodium acetate. Furthermore, the inventive process avoids post-dosing of the carbonate as well.

What is claimed is:

1. A detergent tablet comprising:
from about 80% to about 100%, by weight of the tablet, of detergent granules, the granules comprising
(a) from about 5% to about 30%, by weight of the granules, of an anionic surfactant;
(b) from about 2% to about 15%, by weight of the granules, of acetic acid salt;
(c) from about 50% to about 80%, by weight of the granules, of a solid ingredient comprising an ingredient selected from the group consisting of a solid alkaline neutralizining agent, an aluminosilicate, and mixtures thereof.

2. The tablet of claim 1 which in addition to detergent granules further comprises post-dosed carboxymethyl cellulose.

3. The tablet of claim 2 wherein the amount of carboxymethyl cellulose is in the range of from about 0 to about 10%, by weight of the tablet.

4. The tablet of claim 1 wherein the tablet comprises from about 0% to about 15% of post-dosed carbonate and/or acetate.

5. The tablet of claim 1 wherein the acetic acid salt is obtained by in situ neutralization during detergent granules preparation.

6. The tablet of claim 1 wherein at least about 90% of all acetate and/or carbonate in the tablet is in the detergent granules.

7. The tablet of claim 1 wherein the detergent granules further comprise a nonionic surfactant.

8. The tablet of claim 1 wherein the detergent granules further comprise soap.

9. The tablet of claim 1 wherein the anionic surfactant is selected from the group consisting of alkylbenzene sulphonate, alkyl sulphate, alkyl olefin sulphonate, alkyl ether sulphate and mixtures thereof.

10. The tablet of claim 1 wherein the alkaline neutralizing agent is a carbonate selected from the group consisting of alkali metal carbonates, bicarbonates, sesquicarbonates, burkeite and mixtures thereof.

11. The tablet of claim 1 further comprising a post-dosed ingredient selected from the group consisting of enzymes, bleaches, bleach precursors, fragrances, builders, and mixtures thereof.

12. The tablet of claim 1 which has a tablet strength of at least 20 Newtons.

13. The tablet of claim 1 which dissolves in the laundry machine in less than 5 minutes.
